(19) United States
(12) Patent Application Publication
(10) Pub. No.: US 2024/0423160 A1
(43) Pub. Date: Dec. 26, 2024

(54) SPINNER PLATE FEED DISTRIBUTION SYSTEM

(71) Applicants: Bradley Gleaton, Dallas, TX (US); Randall May, Plano, TX (US)

(72) Inventors: Bradley Gleaton, Dallas, TX (US); Randall May, Plano, TX (US)

(21) Appl. No.: 18/750,447

(22) Filed: Jun. 21, 2024

Related U.S. Application Data
(60) Provisional application No. 63/522,831, filed on Jun. 23, 2023.

(51) Int. Cl. A01K 5/02; B65G 31/04

(52) U.S. Cl. CPC A01K 5/0225; B65G 31/04

(57) ABSTRACT

A feed distribution system for animals comprising a hopper for containing feed, a spinner plate mounted beneath the feed outlet of the hopper, and a motor for rotating the spinner plate. A closure apparatus for the spinner plate includes a central shaft and at least two support legs. The spinner plate is mounted on a motor shaft extending from the motor and is biased upward by the support legs to force the plate towards the bottom of the hopper. In the resting position, a minimal gap is maintained between the spinner plate and the bottom of the hopper such that the spinner plate can rotate without interference, but vermin cannot reach into the gap to access feed that may be on the spinner plate. The support legs are biased by a first biasing member to be in extension to inhibit the edge of the plate from being pulled downward if vermin try to hang from or pull down on the plate. Rotation of the spinner plate generates a centrifugal force to force the support legs into flexion and move the spinner plate downward along the central shaft away from the hopper and, thereby creating a larger gap and allowing the feed to be dispersed during the rotation of the spinner plate.

### RELATED APPLICATION

The present application is a non-provisional application claiming the benefit of priority under 35 U.S.C. § 119 (e) from U.S. Provisional Patent Application No. 63/522,831, filed Jun. 23, 2023, the entire contents of which are expressly incorporated herein by reference into this disclosure.

### FIELD

This disclosure generally relates to a feed distribution system for animals. More specifically, an embodiment of the present invention is a spreader feed distribution system for animals which prevents vermin (e.g., raccoons, squirrels, etc.) from getting to the feed. The device can spread various types of animal feed, including, but not limited to, corn, milo, maze, protein pellets, game feed, bird feed and fish feed, as well as other kinds of materials, such as seeds, sand, grit, salt, fertilizer, and lime.

### BACKGROUND

In the prior art, there is a recognized need to feed animals from a storage container or hopper. Various animals can be fed from animal feed stored in a hopper configured with a spreader that distributes a portion of the stored feed around the hopper. While feeding animals serves many purposes (hunting, birdwatching, animal husbandry, etc.), existing feeders struggle with preventing vermin from accessing and stealing feed.

Various approaches have been attempted to spread stored animal feed, but these suffer from limitations as they are vulnerable to mice, squirrels, raccoons, and other persistent and dexterous vermin. Other techniques, such as fencing, can limit desired larger wildlife like deer and elk, from accessing the feed. By utilizing a spreader that is closed when not in use and resists being pulled open by vermin attempting to access the feed, embodiments of the present invention address these limitations.

### SUMMARY

Embodiments of the present invention disclose a spreader for feed distribution system that solves the aforementioned problems.

According to one embodiment, the feed distribution system includes a hopper for containing feed, a spinner plate mounted beneath the feed outlet of the hopper, and a motor for rotating the spinner plate. A closure apparatus for the spinner plate includes a central shaft and at least two support legs. The spinner plate is mounted on a motor shaft extending from the motor and is biased upward by the support legs to force the plate towards the bottom of the hopper. In the resting position, a minimal gap is maintained between the spinner plate and the bottom of the hopper so that the spinner plate can rotate without interference, but vermin cannot reach into the gap to access feed that may be on the spinner plate. The support legs include at least two linkages and are biased to be in extension by a first biasing member to inhibit the spinner plate from being pulled downward if vermin try to hang from or pull down on the plate. Rotation of the spinner plate generates a centrifugal force that is sufficient to flex the support legs and move the spinner plate downward away from the hopper, creating a larger gap and allowing the feed to be dispersed during the rotation of the spinner plate.

According on another embodiment, a spreader assembly for a feed distribution system may comprise a mounting bracket configured for mounting the spreader assembly to a feed outlet of a feed hopper, a spinner plate rotatably mounted on a lower surface of the mounting bracket, a motor having a motor shaft coupled to the spinner plate for rotation of the spinner plate, and a closure assembly for the spinner plate.

In one embodiment, the motor may be mounted on the upper surface of a mounting bracket with the motor shaft being configured to extend downward through an opening in the mounting bracket toward the spinner plate. In another embodiment, the motor may be configured beneath the spinner plate with the motor shaft being configured to extend upward toward the spinner plate.

The present embodiments offer several advantages over prior art, including an improved closure apparatus that increases the seal between the spinner plate and the hopper. The improved closure apparatus overcomes the need for an additional cage, fencing, or cumbersome vermin prevention system.

### BRIEF DESCRIPTION OF THE DRAWINGS

The accompanying drawings, described below, illustrate various components and interactions found in the embodiments of the present invention.

FIG. 1 is a front perspective view of a spreader mounted to the bottom of a hopper according to an embodiment of the invention.

FIG. 2 is a top perspective view of a spreader according to an embodiment of the invention.

FIG. 3 is a bottom perspective view of the spreader shown in FIG. 2.

FIG. 4 is a bottom view of the spreader shown in FIG. 2.

FIG. 5 is a bottom perspective view of a spreader according to another embodiment of the invention.

FIG. 6 is a front perspective view of the spreader shown in FIG. 5 depicting when the spinner plate is at rest in a closed position.

FIG. 7 is a front perspective view of the spreader shown in FIG. 5 when the spinner plate has been rotated so as to be moved downward along the central shaft to an open position.

FIG. 8 is a front perspective view of the spreader mounted to a spreader mounting bracket according to an embodiment of the invention.

FIG. 9 is a bottom perspective view of the spreader shown in FIG. 8.

FIG. 10 is a side view of a motor for the spreader according to an embodiment of the invention.

FIG. 11 is a top perspective view of a motor for the spreader shown being mounted inside of a hopper and with the motor shaft extending downward below the hopper according to an embodiment of the invention.

FIG. 12 is a cross-sectional view depicting a motor for the mounted on a spreader mounting bracket with the motor shaft extending downward according to an embodiment of the invention.

FIG. 13 is a front perspective view of a spreader with the motor mounted in a motor enclosure with the motor shaft configured to extend upward towards the spreader according to an embodiment of the invention.

FIGS. 14A and 14B are a perspective view and a front view of a support leg for the spreader according to an embodiment of the invention.

FIGS. 15A, 15B, and 15C are a perspective view, front view, and side view of a first biasing member used in the support leg shown in FIG. 1A-C.

FIG. 16 is a perspective view of a spreader according to another embodiment of the invention.

FIG. 17 is a perspective view of a spreader including a collar having a feed chute according an embodiment of the invention.

FIG. 18 is a front perspective view of spreader assembly including a spreader, a motor, and a spreader mounting bracket according to an embodiment of the invention.

FIG. 19 is a top view of the spreader assembly shown in FIG. 18.

FIG. 20 is an exploded view of the spreader assembly shown in FIG. 18.

FIG. 21 is a bottom perspective view depicting mounting of the spreader assembly of FIG. 18 on the underside of a hopper.

FIGS. 22A and 22B are perspective and cross-sectional views of an embodiment of a bushing of the spreader assembly depicted in FIG. 18.

FIGS. 23A and 23B are perspective and cross-sectional views of an embodiment of a spindle bearing cap of the spreader assembly depicted in FIG. 18.

### DETAILED DESCRIPTION

Embodiments of the present invention are further described in detail below with reference to the accompanying drawings and embodiments. The following examples are intended to illustrate the invention, but are not intended to limit the scope of the invention.

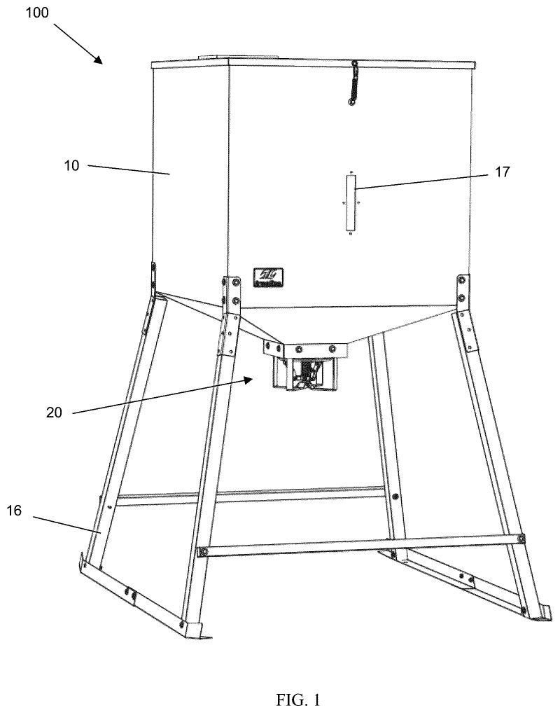

It will be understood that the terms “upper” and “lower,” “front” and “rear,” “top” and “bottom,” and “above” and “below” are used for convenience to describe relative directional reference in the common orientation of a feed distribution system 100 as shown, for example, in FIG. 1.

According to an embodiment of the invention, a feed distribution system 100 comprises a hopper 10, a spreader to disperse the feed 20, a motor to rotate the spreader 30, and a closure assembly 40 for closing the spreader to prevent vermin from accessing the feed.

As shown in FIG. 1, the hopper 10 is a container including an interior cavity 12 in which feed can be stored. The hopper 10 may have a lid or access door on an upper surface of the hopper that can be opened or removed and through which the feed can introduced. The hopper 10 may include a central feed outlet 14 on a bottom surface of the hopper through which the feed may be dispensed. The hopper 10 may be raised above the ground by legs or stand 16. The hopper 10 may further include a window 17 on a side surface through which the level of feed in the interior cavity 12 of the hopper can be viewed.

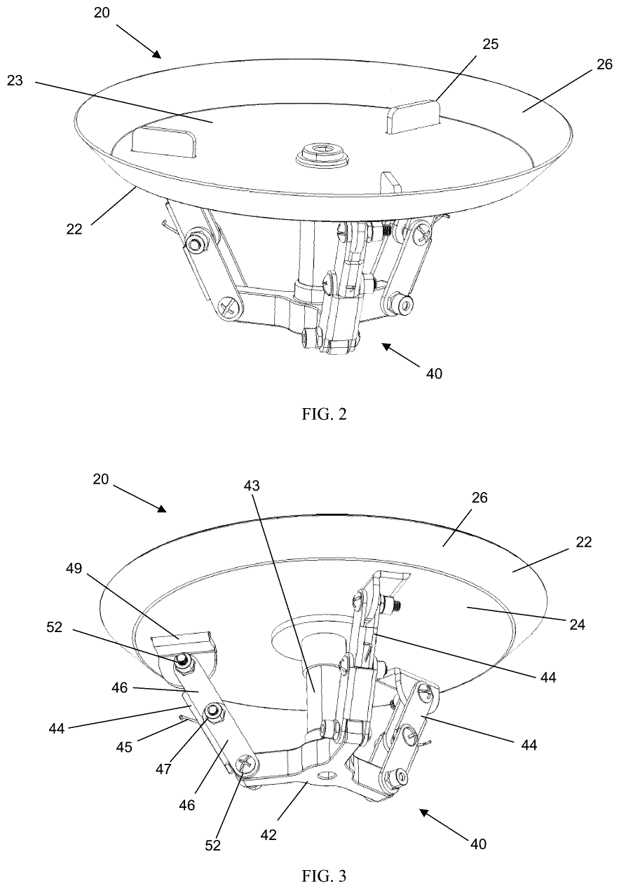

As shown in FIG. 2, the spreader 20 includes a spinner plate 22 which is rotated to disperse the feed in a broadcast pattern. The spinner plate 22 has an upper surface 23 and a lower surface 25, both of which may be substantially planar. The spinner plate 22 may include an upwardly inclined lip 26 forming a rim around the edge of the spinner plate which allows for feed to be dispersed in a more controlled broadcast pattern and with a partially upward trajectory to enable the feed to travel a greater distance.

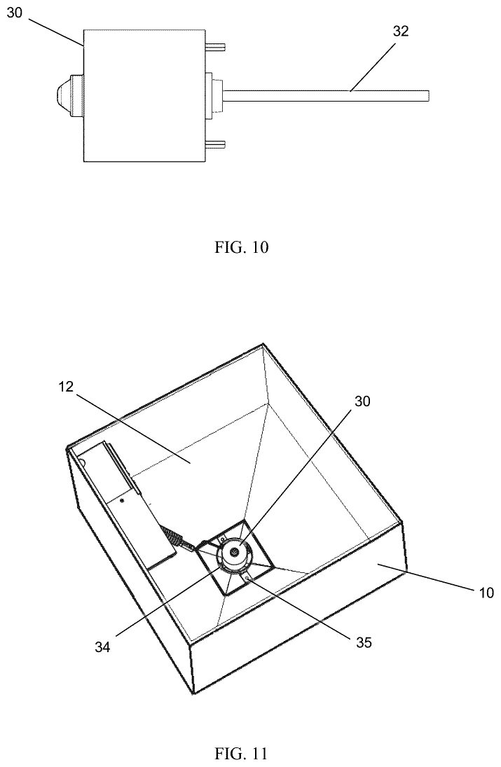

As shown in FIG. 9, the motor 30 may be a rotary motor with a motor shaft or spindle 32 extending from the motor 30. For example, the motor 30 may be an electric motor, but various other conventional types of motors may be used. The motor 30 may be powered by a battery, plug-in electric power, solar power, or any various other power sources. According to one embodiment such as shown in FIGS. 10-11, the motor 30 may be mounted within the interior cavity 12 of the hopper 10 by motor mounting bracket 34, with the motor shaft 32 extending through the feed outlet 14 in the lower end of the hopper 10. According to another embodiment such as shown in FIG. 13, the motor 30 may be mounted beneath the hopper 10 within a motor enclosure 36 and with motor shaft 32 extending upward toward the feed outlet 14. In either of the respective downward or upward configurations of the motor 30, the spinner plate 22 is mounted on the motor shaft 32 beneath the feed outlet 14 of the hopper 10.

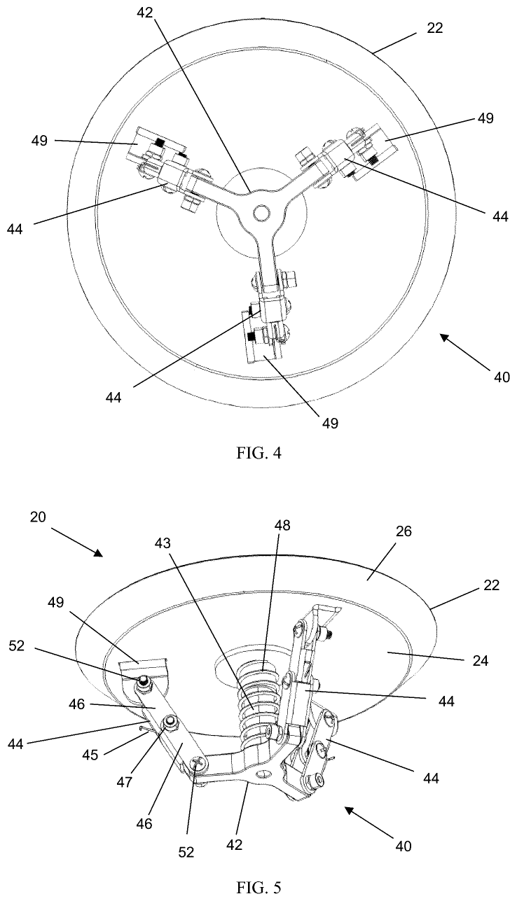

As shown FIGS. 2-4, the closure assembly 40 includes a lower support bracket 42, a central shaft 43, and support legs 44. The central shaft 43 extends between the lower support bracket 42 and the lower surface 25 of the spinner plate 22. The support legs 44 are rotatably coupled at a lower joint 51 on the lower supper bracket 42 and at an upper joint 52 on the lower surface 25 of the spinner plate 22. An upper bracket 49 may be used to couple each of the support legs 44 to the lower surface 25 of the spinner plate 22. The support legs 44 may be connected near the edge of the spinner plate 22, which may provide more support against the spinner plate 22 from tilting.

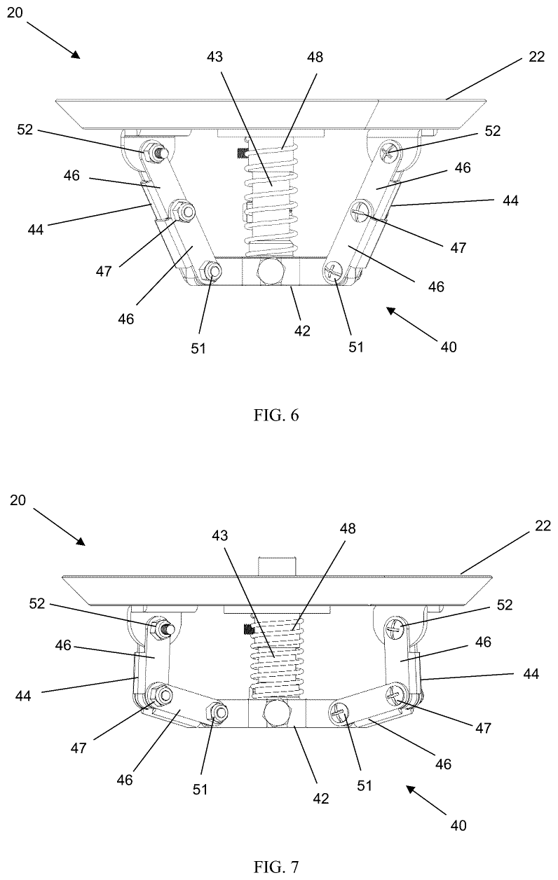

FIG. 6 shows the spreader 20 in a closed position with the spinner plate 22 at rest and the support legs 44 in extension. A minimal gap 28 is maintained between the lip 26 of the spinner plate 22 and the underside of the hopper 10 in the resting position. The gap 28 is sized merely to enable the spinner plate 22 to rotate without interference against the hopper 10, but without vermin being able to reach into the gap 28 to obtain feed that may be contained on the upper surface 23 of the spinner plate 22.

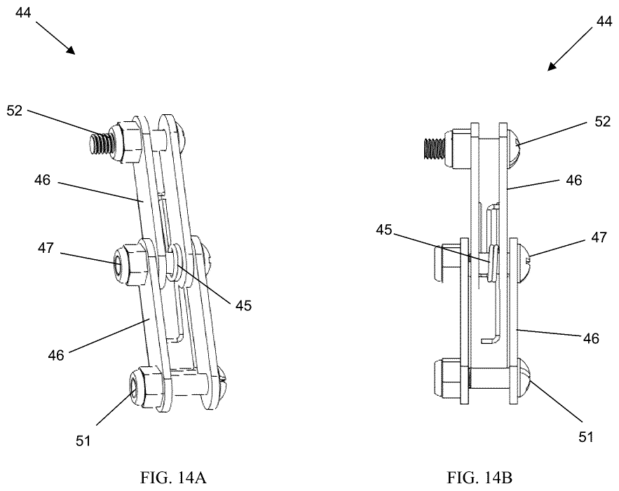

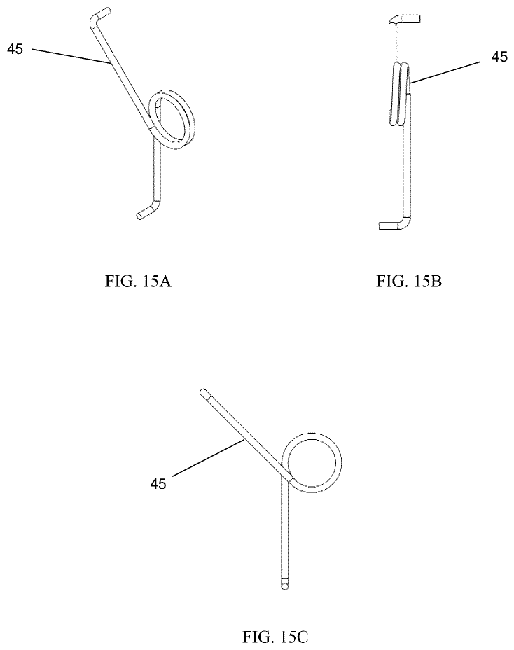

Embodiments of the closure assembly 40 may include two or more support legs 44. The embodiments depicted in the figures include three support legs 44, which may provide additional support against tilting from a downward force that may be exerted at the edge of the spinner plate 22. Each support leg 44 has at least two linkages 46 coupled to each other by a rotatable joint 47. A first biasing member 45 biases the linkages 46 of the support legs 44 toward extension into an over-center orientation when the spinner plate 22 is in the closed position, such as shown in FIG. 6. The support arms are shown in more detail in FIGS. 14A-B. When in an over-center orientation, the linkages 46 of the support legs 44 are locked in extension and are inhibited from rotating back into flexion when a laterally downward and/or radially outward force is exerted on the spinner plate 22, such as may be experienced when vermin attempt to pull down or hang from the spinner plate 22 or lower support bracket 42. The support legs 44 prevent the spinner plate 22 from being pulled downward away from the underside of the hopper 10 when the spinner plate 22 is at rest. The support arms 44 also provide support against tilting along the edge of the spinner plate 22, which is a location from which vermin may attempt to pull down or hang to try to reach the feed.

According to one embodiment such as shown in FIGS. 14A-B and 15A-C, the first biasing member 45 may be a torsion spring disposed around joint 47 between the linkages 46 of each support leg 44. In addition or in the alternative, torsion springs may be disposed at the lower joint 51 between the support leg 44 and the lower support bracket 42 and/or the upper joint 52 between the support leg 44 and the spinner plate 22. According to another embodiment as show in FIG. 16, the first biasing member 45 may comprise one or more extension springs which are respectively connected between the central shaft 43 and the joint 47 between the linkages 46 of each support leg 44.

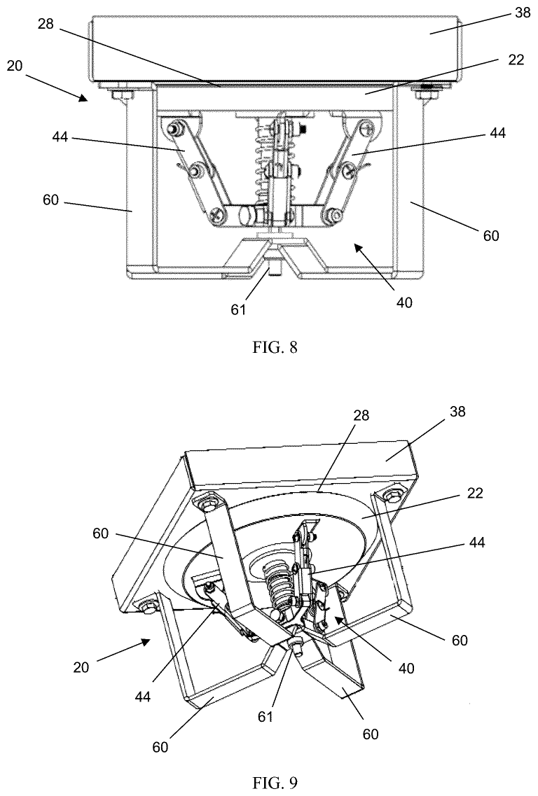

As shown in the embodiments in FIGS. 5-9, the closure assembly may further include a second biasing member 48 that biases the spinner plate 22 to be forced upward towards the underside of the hopper 10. For example, the second biasing member 48 may be a compression spring disposed along the central shaft 43 which is biased to push the spinner plate upward.

Upon rotation of the spinner plate 22 by the motor 30, a centrifugal force is generated that forces the support arms 44 outward. When the centrifugal force is sufficient to overcome the biasing force from the first biasing member 45, the linkages 46 of the support arms 44 are forced into flexion, which exerts a force pulling the spinner plate 22 downward along the central shaft 43 away from the underside of the hopper 10. This increases the size of the gap 28, which enables the feed to be dispersed as the spinner plate 22 rotates. FIG. 7 depicts the spreader 20 in an open position when the spinner plate 22 has been in rotation and has moved downward along the central shaft 43, and wherein the linkages 46 of the support arms 44 are in flexion and the second biasing member 48 has been at least partially compressed. When the motor 30 slows down or stops rotating, the first biasing member 45 causes the support legs 44 to extend and the second biasing member 48 extends, forcing the support plate 22 back up the central shaft 43 toward the bottom of the hopper 10.

The second biasing member 48 and the support arms 44 exert an upward biasing force with a magnitude that can resist a downward force exerted by vermin hanging on to or pulling down the edge of the spinner plate 22, the lower support bracket 42, or any of the support legs 44. When the motor 30 rotates the spinner plate 22 at a high enough speed to generate a downward force that is sufficient to overcome the upward biasing force of the support arms 44 and the second biasing member 48, the spinner plate 22 moves down along the central shaft 43. Preferably, the design is optimized such that the downward force required to overcome upward biasing force the move the spinner plate 22 down is substantially greater than a force that could be exerted by vermin. For example, a sufficient downward force may be generated when the spinner plate 22 is rotated between about 700 to 3,000 rotations per minute (RPM), and preferably, between about 2,000 to 2,500 RPM.

According to an embodiment such as shown in FIG. 2, the spinner plate 22 may include projections 25 that extend upward from the upper surface 23 of the spinner plate 22 and are oriented radially to assist in propelling the feed during dispersal as the spinner plate 22 rotates. The projections 25 may be disposed on or formed integrally with the upper surface 23 of the spinner plate 22. The projections 25 may alternatively be formed as a portion of upper brackets 49 which extend upward through slots formed within in the spinner plate 22.

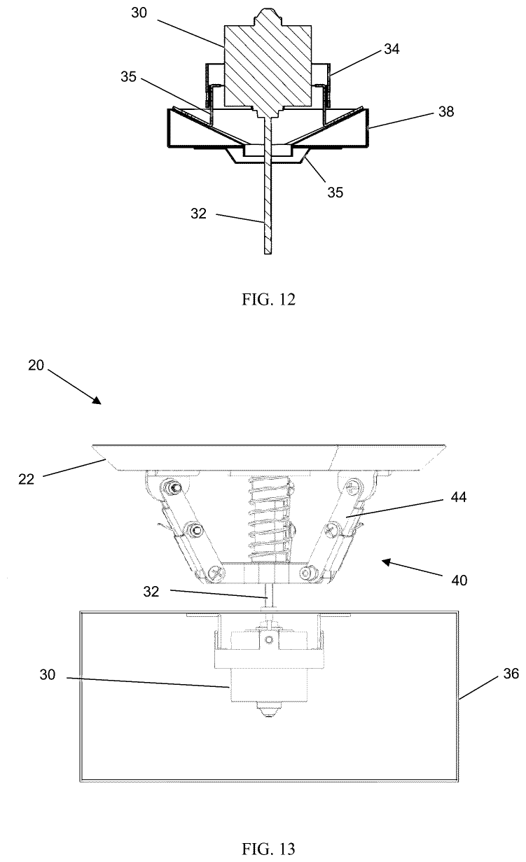

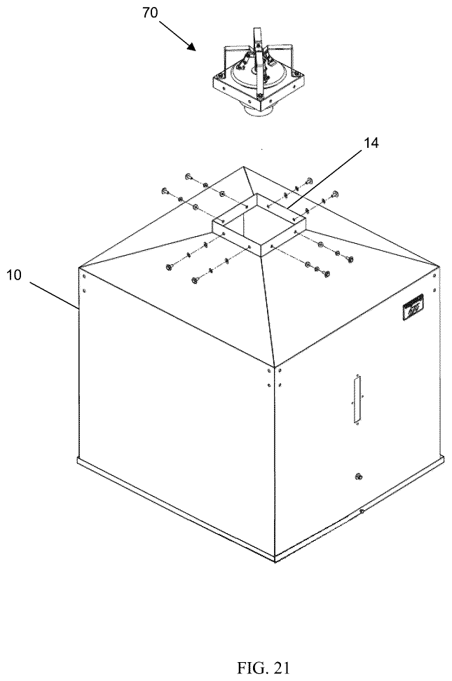

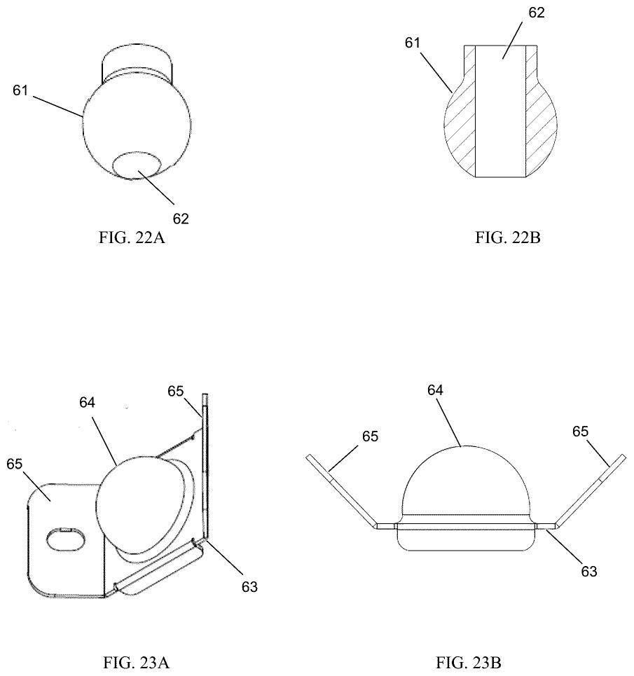

According to embodiments such as shown in FIGS. 1, 8, 9, 12, and 17-21, the spreader 20 may be attached to a spreader mounting bracket 38 that is configured for mounting the spreader 20 to the feed outlet 14 of a hopper 10. In another embodiment, the spreader 20 may be mounted directly to the feed outlet 14 on the underside of hopper 10. A funnel plate 39 may be disposed on the underside of the spreader mounting bracket 38 or the underside of the feed outlet 14 above the spinner plate 14, which may direct the feed toward the center of the spinner plate 22 as it is dispensed from the hopper 10. Protective bars 60 may be disposed around the spreader 20 and closure assembly 40 and connected to the lower surface of spreader mounting bracket 38 or the underside of hopper 10. The protective bars 60 may protect the spreader 20 from being bumped into or dislodged by animals that walk beneath the hopper 10. A distal end of the motor shaft 32 may extend through an opening in the protective bars 60 and be rotatably secured on the underside of the protective bars 60 by spindle end cap 63, such as a cap nut or a spindle bearing cap. In an embodiment depicted in FIGS. 22A-B and 23A-B, a ball-shaped bushing 61 having a through-hole 62 vertically therethrough may be disposed at the distal end of the motor shaft 32, which is received by a corresponding ball-shaped socket 64 in the spindle end cap 63. The spindle end cap 63 may include wings 65 configured to be attached to the protective bars 60. Ball-shaped bushing 61 and socket of the spindle end cap 63 may allow for pivoting of the motor 30 and may serve to reduce to vibration of the motor 30 and motor shaft 32.

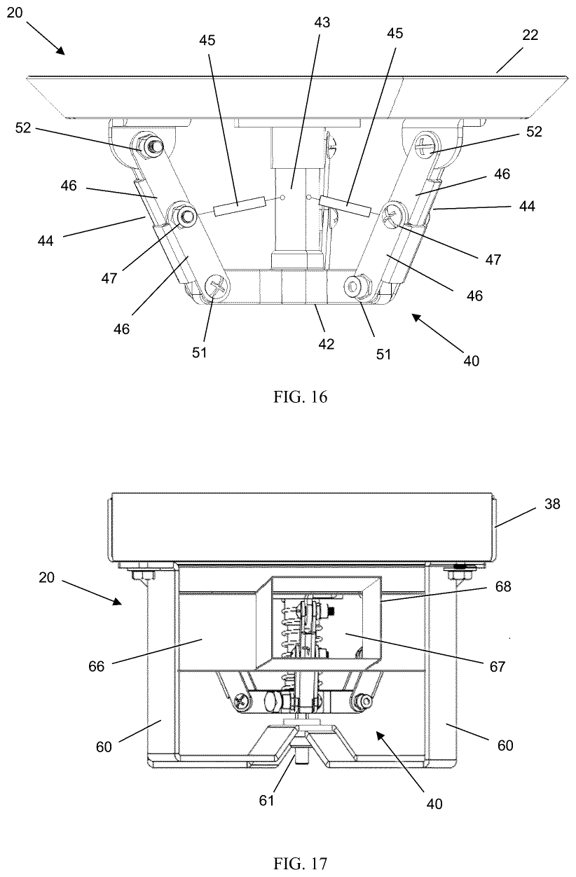

According to an embodiment such as shown in FIG. 17, a collar 66 may be disposed around the spreader 20 on the underside of the hopper 10. The collar 66 may include an opening 67 through which the feed is dispersed to concentrate the dispersal of the feed in a limited arc as opposed to a full 360° broadcast dispersal pattern. A chute 68 may extend from the collar 66 around the opening 67 which may deflect the feed to travel more uniformly within a certain direction and which may also enable the feed to travel a greater distance. The collar 66 may provide additional protection from vermin reaching in to access the feed disposed on the spinner plate 22.

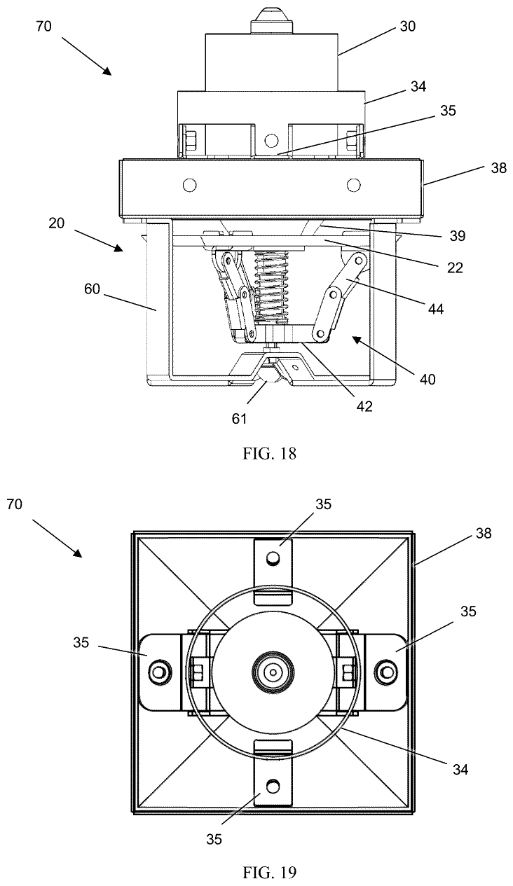

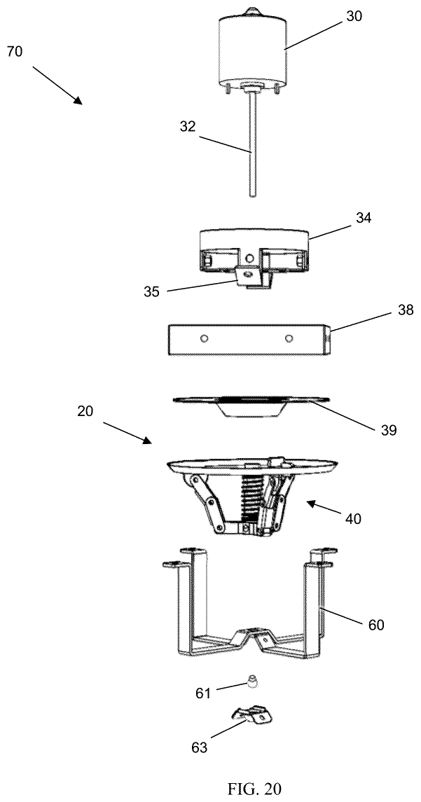

According to an embodiment shown in FIGS. 18-20, a spreader assembly 70 may be assembled as a unit comprising the spreader 20, closure assembly 40, motor 30, motor mounting bracket 34, and protective bars 60, which may be attached to a spreader mounting bracket 38. The spreader mounting bracket 38 may then be used to secure the unit of the spreader assembly 70 to the feed outlet 14 on the underside of the hopper 10 such as shown in FIG. 20. The spreader assembly 70 may provide for easier installation of the unit onto the hopper 10.

According to an embodiment shown in FIG. 19, the motor mounting bracket 34 may be a gimbal mount, which may allow the motor 30 to pivot around two or more axis. The motor mounting bracket 34 may include two or more supports 35, and preferably four or more supports 35, which may secure the motor mounting bracket 34 to the spreader mounting bracket 38.

It will be appreciated that although the embodiments described herein relate to animal feeding hoppers such as those for distributing corn for wild deer, the disclosed process is applicable to many other types of materials that need to be spread over an area, but need pest-protection, such as scattering stored seeds for planting.

The above description is only to preferred embodiments of the present invention and it should be noted that those skilled in the art can make improvements and modifications without departing from the technical principles of the present invention and as such, variations are also considered to be the scope of protection of the present invention.

What is claimed is:

1. A feed distribution system comprising:
a feed hopper having an interior cavity and a feed outlet;
a spinner plate disposed beneath the feed outlet of the hopper;
a motor having a motor shaft coupled to the spinner plate for rotation of the spinner plate; and
a closure assembly comprising:
a support bracket,
a central shaft, and
at least two support legs rotatably coupled to the support bracket and to the spinner plate, each support leg having at least two linkages that are rotatably coupled together and
a first biasing member that biases the linkages to be in extension,
wherein when the spinner plate is at rest, the support legs force the spinner plate upward along the central shaft towards the hopper to a closed position and inhibit the spinner plate from being pulled downward away from the hopper by a downward force exerted on the spinner plate,
wherein when the motor rotates the spinner plate, a centrifugal force is exerted which forces the linkages of each of the support legs into flexion and moves the spinner plate downward along the central shaft away from the hopper.

2. The feed distribution system of claim 1, wherein the linkages of the support legs are biased toward an over-center orientation which inhibits the linkages from being forced into flexion.

3. The feed distribution system of claim 1, wherein the first biasing member is a torsion spring disposed on the joint between the linkages of the support legs.

4. The feed distribution system of claim 1, wherein the support legs are rotatably coupled to the spinner plate near an edge of the spinner plate.

5. The feed distribution system of claim 1, further comprising a second biasing member that is biased to force the spinner plate toward the hopper in the closed position.

6. The feed distribution system of claim 5, wherein the second biasing member is a compression spring disposed along the central shaft.

7. The feed distribution system of claim 1, wherein the motor is mounted inside the interior cavity of the hopper and the motor shaft extends through the feed outlet to be coupled with the spinner plate.

8. The feed distribution system of claim 1, wherein the motor is mounted beneath the spinner plate and motor shaft extends upward to be coupled with the spinner plate.

9. The feed distribution system of claim 1, wherein when the spinner plate is in the resting position, a gap is maintained between the spinner plate and the lower surface of the hopper which is sized such that the spinner plate can rotate without interference but which is small enough to prevent vermin from accessing the feed disposed on the spinner plate.

10. The feed distribution system of claim 1, wherein when the spinner plate is rotated such that it is moved downward along the central shaft, the gap between the spinner plate and the lower surface of the hopper is increased to allow feed to be dispersed.

11. The feed distribution system of claim 1, wherein the spinner plate includes an upwardly inclined lip around the spinner plate.

12. The feed distribution system of claim 1, further comprising protective bars disposed around the spinner plate and closure system.

13. A spreader assembly for a feed distribution system comprising:
a mounting bracket configured for mounting the spreader assembly to a feed outlet of a feed hopper, the mounting bracket having an upper surface and a lower surface;
a spinner plate rotatably mounted on the lower surface of the mounting bracket;
a motor having a motor shaft coupled to the spinner plate for rotation of the spinner plate; and
a closure assembly comprising:
a support bracket,
a central shaft, and
at least two support legs rotatably coupled to the support bracket and to the spinner plate, each support leg having at least two linkages that are rotatably coupled together and
a first biasing member that biases the linkages to be in extension,
wherein when the spinner plate is at rest, the support legs force the spinner plate upward along the central shaft towards the lower surface of the mounting bracket to a closed position and inhibit the spinner plate from being pulled downward away from the mounting bracket by a downward force exerted on the spinner plate,
wherein when the motor rotates the spinner plate, a centrifugal force is exerted which forces the linkages of each of the support legs into flexion and moves the spinner plate downward along the central shaft away from the mounting bracket.

14. The spreader assembly of claim 13, wherein the motor is mounted on the upper surface of the mounting bracket, and the motor shaft being configured to extend downward through an opening in the mounting bracket toward the spinner plate.

15. The spreader assembly of claim 13, wherein the motor is configured beneath the spinner plate, and the motor shaft being configured to extend upward toward the spinner plate.
